(19) United States
(12) Patent Application Publication
(10) Pub. No.: US 2004/0107425 A1
(43) Pub. Date: Jun. 3, 2004

(54) Disc apparatus with device for preventing ejection of cracked disc

(76) Inventor: Chiu-An Huang, Baojhong Township (TW)

Correspondence Address: SNELL & WILMER, ONE ARIZONA CENTER, 400 EAST VAN BUREN, PHOENIX, AZ, 850040001

(21) Appl. No.: 10/717,696

(22) Filed: Nov. 20, 2003

(30) Foreign Application Priority Data
Dec. 2, 2002 (TW) 91134915

(51) Int. Cl. G11B 17/03; G11B 17/04; G11B 33/02

(52) U.S. Cl. 720/610

(57) ABSTRACT

A device and a disc data reading apparatus with the device for preventing ejection of cracked discs are provided. The device includes a cover and a panel. The cover includes a first lock portion and the panel includes a second lock portion correspondingly. The engagement between the first lock portion and the second lock portion restricts relative displacement between the cover and the panel, so that a cracked disc is blocked from ejecting out of the disc data reading apparatus.

### CROSS REFERENCE TO RELATED APPLICATIONS

This application claims priority of Taiwan Patent Application Serial No. 091134915 entitled “Disc Apparatus with Device for Preventing Cracked Disc from Shooting Out,” filed Dec. 2, 2002.

### FIELD OF INVENTION

The present invention provides a disc data reading apparatus for preventing ejection of cracked discs.

### BACKGROUND OF THE INVENTION

As the optical disc device technology develops, the speed and performance of the optical disc device become higher and higher. The quality of discs on the market, however, is not always good enough for high performance. A cracked disc often ejects out of the device and even hurts users. Therefore, an effective design for preventing ejection of the cracked disc is a focus of the modern optical disc device technology.

As shown in FIG. 1, a disc data reading apparatus 100 includes a tray 105 and a panel 101. The tray 105 includes a cover 103 on one end. A cracked disc 110 usually ejects out of the disc data reading apparatus 100 through an opening 130 between the panel 101 and the cover 103. Conventionally, downward-bent end of an upper cover 112 becomes a blocking device 114 to prevent ejection of the possible cracked disc 110. The blocking device 114 blocks the ejecting cracked disc 110 due to the strength of the upper cover 112.

However, the cracking of the disc is often accompanied by a strong force. The force usually downwardly pushes the tray 105 to expand the opening 130. In this situation, the cracked disc 110 ejects out from below the blocking device 114. To overcome the problem, a modified design adds one or more blocks 118 under the tray 105. The blocks 118 are very close to and even touch the chassis 116 of the disc data reading apparatus 100. When the tray 105 is downwardly pushed, the blocks 118 restrict the excessive displacement of the tray 105 by the support of the chassis 116. Therefore, the cracked disc 110 cannot pass through the blocking device 114.

The above designs still fail sometimes, because the force produced by the cracked disc can upwardly push the upper cover 112 to expend the opening 130. The cracked disc 110 is still able to eject out of the disc data reading apparatus 100 in this situation.

### SUMMARY OF THE INVENTION

An aspect of the present invention is to provide a device used in a disc data reading apparatus for reducing the displacement of the cover caused by a cracked disc and preventing ejection of the cracked disc.

The present invention provides a device used in a disc data reading apparatus for preventing ejection of a cracked disc. In a first embodiment of the present invention, the device includes a cover and a panel. The cover has a protrusion. The panel has an opening and a recession which corresponds to the protrusion of the cover. The cover is able to selectively cover the opening of the panel. When the cover partially covers the opening, the protrusion of the cover is received in the recession of the panel. When a disc cracks in the apparatus, it is often accompanied by a strong force. The force usually downwardly pushes the tray and/or upwardly pushes the upper cover of the disc data reading apparatus. The relative displacement of the cover and the panel is restricted by the engagement between the protrusion of the cover and the recession of the panel. Therefore, the cracked disc is effectively blocked in the disc data reading apparatus.

In a second embodiment of the present invention, the device includes a cover and a panel. The cover has a recession. The panel has an opening and a protrusion which corresponds to the recession of the cover. The cover is able to selectively cover the opening of the panel. When the cover partially covers the opening, the protrusion of the panel is received in the recession of the cover. When a disc cracks in the apparatus, it is often accompanied by a strong force. The force usually downwardly pushes the tray and/or upwardly pushes the upper cover of the disc data reading apparatus. The relative displacement of the cover and the panel is restricted by the engagement between the recession of the cover and the protrusion of the panel. Therefore, the cracked disc is effectively blocked in the disc data reading apparatus.

The present invention also provides a disc data reading apparatus with the above-mentioned device for preventing ejection of cracked discs.

### BRIEF DESCRIPTION OF THE DRAWINGS

The present invention can be more clearly understood from the following detailed description and drawings.

FIG. 1 illustrates a disc data reading apparatus of the prior art with a cracked disc;

FIG. 2A illustrates the cover being away from the panel in accordance with the first embodiment of the present invent;

FIG. 2B illustrates the cover touching the panel in accordance with the first embodiment of the present invent;

FIG. 3A illustrates the cover being away from the panel in accordance with the second embodiment of the present invent; and

FIG. 3B illustrates the cover touching the panel in accordance with the second embodiment of the present invent.

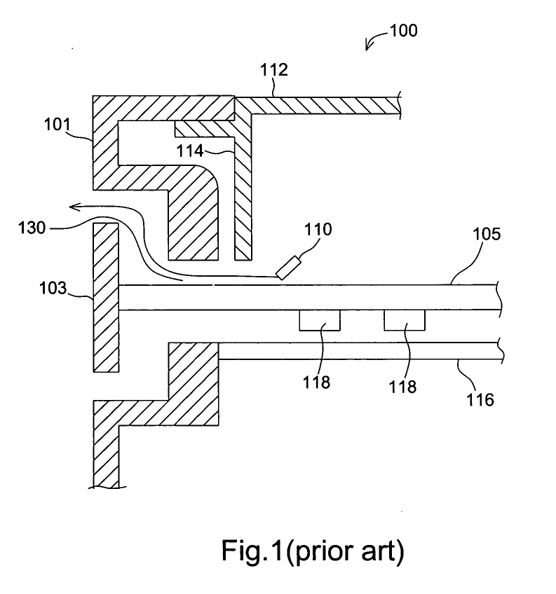

### DETAILED DESCRIPTION

The present invention provides a device used in a disc data reading apparatus for preventing an ejection of a possibly cracked disc. The disc data reading apparatus mentioned here are Compact Disc Drive, Compact Disc Recordable Drive, Compact Disc Rewritable Drive, Digital Versatile Disc Drive, Digital Versatile Disc Recordable Drive, Digital Versatile Disc Rewritable Drive, or any other apparatus with similar functions and structures. Some of the preferred embodiments of the present inventions are mentioned below.

### First Embodiment

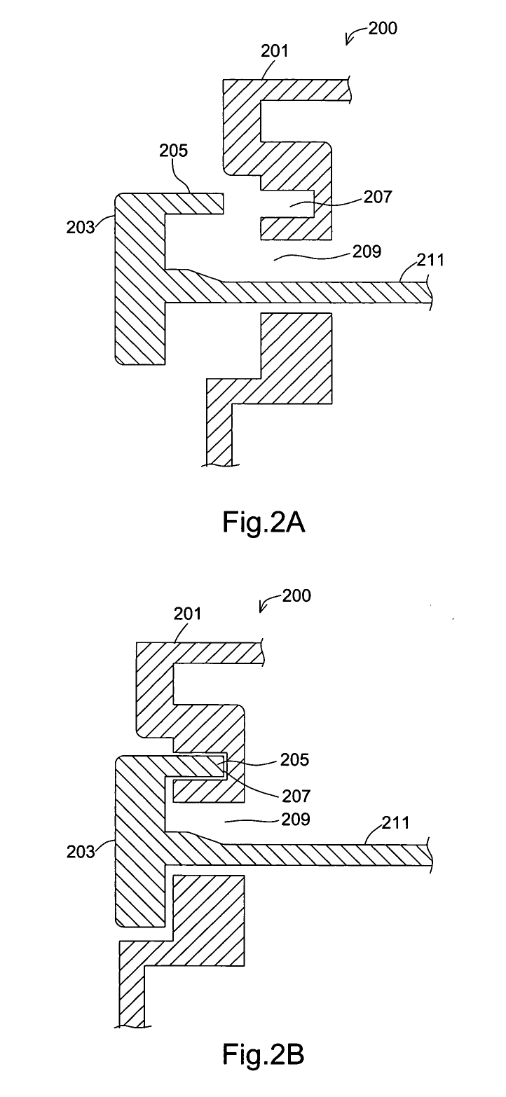

FIG. 2A shows a device used in a disc data reading apparatus 200 in accordance with the present invention. The disc data reading apparatus 200 includes at least a panel 201 and a tray 211. The tray 211 includes a cover 203 and a first lock portion 205 of the cover 203. The first lock portion 205 is a protrusion in this embodiment. The panel includes an opening 209 and a second lock portion 207 corresponding to the first lock portion 205. The second lock portion 207 is a recession in this embodiment. The cover 203 is able to selectively cover the opening 209.

FIG. 2B shows the cover 203 touching the panel 201. When the disc cracks in the disc data reading apparatus 200, it is often accompanied by a strong force. The force usually downwardly pushes the tray 211 and/or upwardly pushes the upper cover (not shown in the FIG. 2B) of the disc data reading apparatus 200. The relative displacement of the cover 203 and the panel 201 is restricted by the engagement between the protrusion 205 of the cover 203 and the recession 207 of the panel 201. Therefore, the cracked disc is effectively blocked in the disc data reading apparatus 200. When the cover 203 covers the panel 201, the protrusion 205 is received in the recession 207. It should be noted that although the second lock portion 207 uses a recession in an exemplary embodiment, it could be other similar structure, such as a slot.

### Second Embodiment

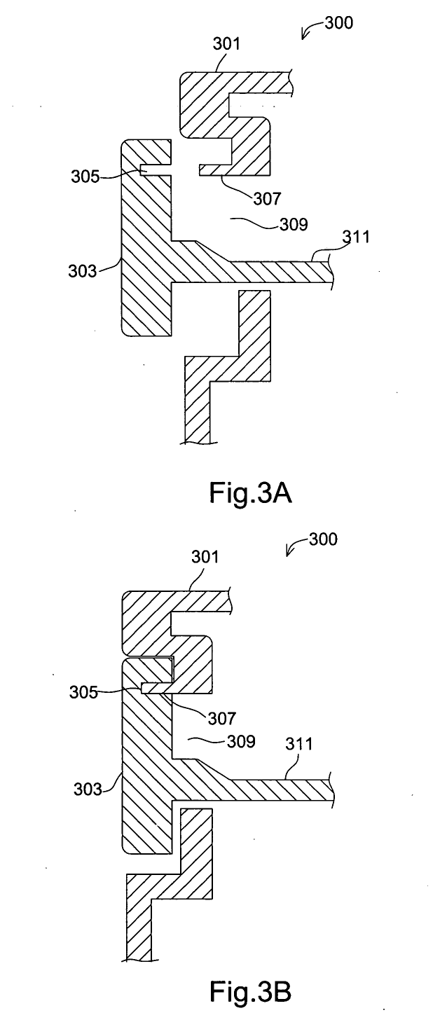

The FIG. 3A shows a device used in a disc data reading apparatus 300 in accordance with the present invention. The disc data reading apparatus 300 includes at least a panel 301 and a tray 311. The tray 311 includes a cover 303 and a first lock portion 305 of the cover 303. The first lock portion 305 is a recession in this embodiment. The panel includes an opening 309 and a second lock portion 307 corresponding to the first lock portion 305. The second lock portion 307 is a protrusion in this embodiment. The cover 303 is able to selectively cover the opening 309.

The FIG. 3B shows the cover 303 touching the panel 301. When the disc cracks in the disc data reading apparatus 300, it often accompanied by a strong force. The force usually downwardly pushes the tray 311 and/or upwardly pushes the upper cover (not shown in FIG. 3B) of the disc data reading apparatus 300. The relative displacement of the cover 303 and the panel 301 is restricted by the engagement between the recession 305 of the cover 303 and the protrusion 307 of the panel 301. Therefore, the cracked disc is effectively blocked in the disc data reading apparatus 300. When the cover 303 covers the panel 301, the protrusion 307 is received in the recession 305. It should be noted that although the first lock portion 305 is a recession in an exemplary embodiment, it could also be another similar structure, such as a slot.

The spirit and scope of the present invention can be clearly understood by the above detail descriptions of the preferred embodiments. The embodiments are not intended to construe the scope of the invention. Contrarily, various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

I claim:

1. A disc data reading apparatus, comprising:
a cover having a first lock portion; and
a panel having an opening and a second lock portion corresponding to the first lock portion, the second lock portion being engaged with the first lock portion as the cover covers the opening of the panel;
wherein the engagement between the first lock portion and the second lock portion restricts relative displacement between the cover and the panel, so that a cracked disc is blocked from ejecting out of the disc data reading apparatus.

2. The disc data reading apparatus of claim 1, wherein the first lock portion is a protrusion and the second lock portion is a depression.

3. The disc data reading apparatus of claim 2, wherein the protrusion is received in the depression when the cover partially covers the panel.

4. The disc data reading apparatus of claim 1, wherein the first lock portion is a protrusion and the second lock portion is a slot.

5. The disc data reading apparatus of claim 4, wherein the protrusion is received in the trench when the cover partially covers the panel.

6. The disc data reading apparatus of claim 1, wherein the first lock portion is a depression and the second lock portion is a protrusion.

7. The disc data reading apparatus of claim 6, wherein the protrusion is received in the depression when the cover partially covers the panel.

8. The disc data reading apparatus of claim 1, wherein the first lock portion is a slot and the second lock portion is a protrusion.

9. The disc data reading apparatus of claim 8, wherein the protrusion is received in the slot as the cover partially covering the panel.
